(19) United States
(12) Patent Application Publication
(10) Pub. No.: US 2002/0109738 A1
(43) Pub. Date: Aug. 15, 2002

(54) Recording medium printing apparatus

(76) Inventor: Chizuo Ozawa, Shiojiri City (JP)

Correspondence Address: Newton H Lee Jr, 39 Parker, Irvine, CA, 92618, US

(21) Appl. No.: 09/523,948

(22) Filed: Mar. 13, 2000

(30) Foreign Application Priority Data
Apr. 19, 1999 (JP) 11-110642

(51) Int. Cl. B41J 3/00

(52) U.S. Cl. 347/2; 347/106

(57) ABSTRACT

Printing with water based ink, directly upon media of the digitally recorded compact memory disc types, including CD's and DVD's by applying a print receiving layer to the discs, then printing on the receiving layer with water based ink, and, thereafter, applying a protective coating over the printed material to protect it from ultraviolet rays and moisture.

### FIELD OF THE INVENTION

This invention is related to a method of the printing on surfaces of water proof media such as digital recording discs, including CD and DVD, and the like with water based ink.

### BACKGROUND OF THE INVENTION

Ink jet printers, for example, use water based ink and generally use recording papers that adequately absorb water ink as recording media. When the water proof surfaces of recording media such as non-printable plastic recording discs, such as digitally recorded discs are printed to provide labels by using ink jet printers, ink will not be absorbed and easily peeled off.

Also, if water contacts on the printing surface of a non-printable CD, or if the said surface is contacted by a dirty hand, ink may easily bleed, flow over, or peel off.

On the other hand, such discs may have labels that can be printed upon with water based ink. However, even in this case, for example, if this disc is stored under very humid environment, ink is likely to bleed.

In addition, the printing label, printed with water based ink is not adequate for long-term storage because it deteriorates and it turns brown when it is exposed to ultraviolet rays.

In the co-owned application, Ser. No. ______, filed ______ for “Printing Apparatus and Method” there is disclosed a method of printing upon materials of different thicknesses, including plastic and other panels, wherein the plastic panels are not susceptible of water based ink printing, unless the panels are coated to provide a printing layer of a water emulsion. The printed panel is also provided with an ultra violet and water proof coating.

### SUMMARY OF THE INVENTION

A object of this invention is to provide a recording medium printing method that can create durable printed images on the surface of a recording medium such as CD's, DVD's and the like with water based ink which does not peel, bleed or deteriorate.

The recording disc printing method of this invention prints with water ink on the surface of the recording medium and includes process of creating a printed surface protection film on the said printed surface which protects the printed layer from ultraviolet rays and moisture. The methods of creating a printed surface protection film include a spray painting method, a spin coating printing, screen painting, and a hand painting.

It is desirable to create a water ink image receiving layer on the surface of this recording medium prior to printing if the surface of the recording medium is water proof. This ink image receiving layer can also be created by the methods referred to above.

The printing method of this invention is adapted for printing on the surfaces of compact discs or digital video discs. Also, it is desirable to use an ink jet printer that has a non-contacting printing construction.

This invention has other features and advantages which will become apparent or will be described in the following specification.

### BRIEF DESCRIPTION OF THE DRAWINGS

FIG. 1 is a view in section through a recording disc having painted layers according to the invention;

FIG. 2 is a perspective view showing one painting method for coating a recording disc; and

FIG. 3 is a perspective of an example of a paint device to paint a film on the surface of the recording disc.

### DESCRIPTION OF THE PREFERRED EMBODIMENT

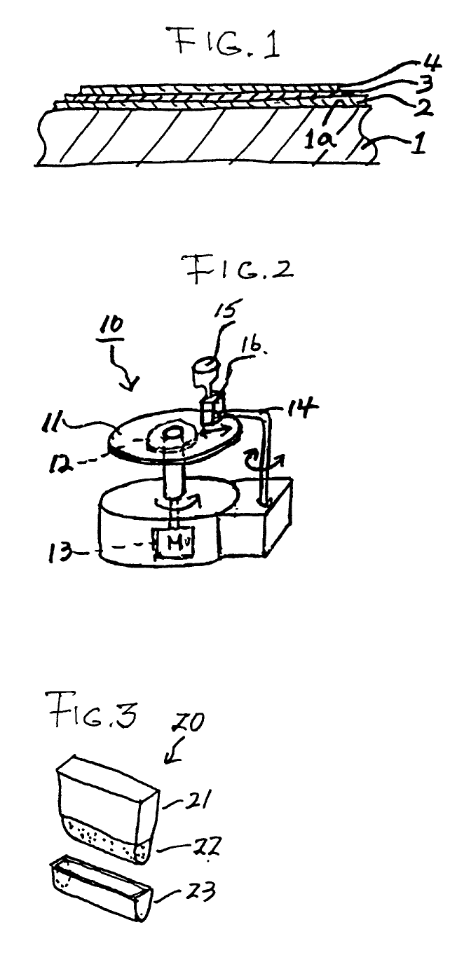

FIG. 1 indicates the composition of a layer when the printing surface is created on the surface of a non-printable recording disc 1 by using an ink jet printer. Referring to this view, the printing method of this invention will be understood to create an image receiving layer 2 for water ink on the surface la of the disc 1. Next, on the surface of this dried image receiving layer 2, printing with water ink of an image 3 can be applied by using, say, an ink jet printer. After that, a printed surface protection film 4 is applied and covers the surface of the created printed image 3.

The image receiving layer 2 is a layer with superior water ink absorption. For example, its main components are water emulsion, water soluble acrylic resin, vinyl alcohol resin, and acetic acid vinyl resin. It is created by painting and drying the mixed solution including foam remover, surface adjuster, surfactant, adherence enhancer, or alcohol solution.

Also, the printed surface protection film 4 is a layer to improve the ability to prevent brown-coloring and provide water proofing of the printed surface image 3. For example, its main components are acrylic resin, silicon acrylic resin, and polyester resin. It is created by painting and drying the solution made with organic and inorganic ultraviolet rays absorbent, oxidization preventing chemical, hulse, foam remover, surface adjuster.

These image receiving layer 2 and printed surface protection film 4 can be created by the spray gun painting method, the spin coating painting method, screen painting, or hand painting by using a brush, and the like methods

Furthermore, as a recording medium for this printing method, there are DVD, FD, MD, and DAT, and others besides CD discs.

Next, FIG. 2 indicates an example of a painting device that can be used to apply the image receiving layer 2 and the printed surface protection film 4 on a recording medium surface. As indicated in this view, the painting device 10 has a rotating table 12 to rotate a CD 11 or other disc around its center and a driving motor 13 for this rotating table 12. Also, it has the pivotal arm 14 that can swing along an arc from its center to the outer circumference along the surface of the CD 11 on the rotating table 12, the chemical solution stopper 15 and the chemical solution painting pad 16 that are installed on the front edge of the arm 14, and the driving mechanism (not indicated in the figure) to swing the arm 14.

In use, the printed CD 11 or other disc, is rotated by placing it on the rotating table 12 and swinging the pad 16 installed at the front edge of the swing arm 14 from the center or outer circumference along the surface of the rotating CD 11. The pad 16 is made from absorbent materials and contains the solution that is supplied from the chemical stopper 15. Therefore, when the pad 16 is moved along the surface, the solution is applied to the surface. Since the disc 11 continues to rotate, the solution is applied over the entire surface of the disc 11 while the pad 16 swings in the direction of a radius of the disc. A spray nozzle can be used in place of the pad.

Next, a painting tool that is indicated in FIG. 3 can be used to hand-paint the image receiving layer or the printed surface protection film. This painting tool 20 is made of a rectangular solid solution storing tank part 21, a painting pad 22 made of material capable of capillary action on the bottom edge, and a cap 23 of this painting pad 22.

The chemical remaining inside of the solution storing tank part 21 penetrates into the painting pad 22 through a connecting hole (not indicated in the figure) on the lower side. The amount of chemical solution supplied to the pad 22 can be adjusted by creating this tank part 21 from plastic, and squeezing it manually. The chemical solution can be applied on the printing surface by holding the tank part 21 with a hand, removing the cap 23, and rubbing the printing surface by the pad 22.

As explained above, the a recording medium printing method of this invention creates printed surface protection film that absorbs or intercepts (blocks) ultraviolet rays and is water proof on the printing surface on the disc. Therefore, this invention can create durable and weather resistant printing surface on the CD and other record discs.

Also, this invention can create a permanent and hard-to-peel printing surface by using an ink jet printer by creating the image receiving layer on the surface of the disc, which is not adequate for the printing with water ink.

The invention is best defined in the following claims.

1. The method for printing on a disc recording medium including the steps of printing with water based ink on the surface of a recording disc and forming a printed surface protection film on the said printed surface.

2. The method of claim 1 wherein said film has at least one layer of ultraviolet ray protection.

3. The method of claim 1, wherein said film has at least one layer of water proofing.

4. The method of claim 2, wherein said film is applied by printing.

5. The method of claim 1, wherein the printing on the surface of the said recording medium is performed by an ink jet printer.

6. The method of claim 1, including the steps of providing a water based ink image receiving layer on the surface of the recording disc before printing and applying said protection layer after printing.

7. The method of claim 6, wherein said image receiving layer or the said printed surface protection film are applied by painting.

8. The method of claim 6, including printing on the surface of the said recording disc with an ink jet printer.

9. The method of claim 7, including printing on said image receiving layer with an ink jet printer.
